(19) United States
(12) Patent Application Publication
(10) Pub. No.: US 2007/0188593 A1
(43) Pub. Date: Aug. 16, 2007

(54) Apparatus and method for managing content with category information in a mobile communication terminal

(75) Inventor: Kyoung-Soo Min, Anyang-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/654,488

(22) Filed: Jan. 17, 2007

(30) Foreign Application Priority Data
Jan. 17, 2006 (KR) 10-2006-0004868

(51) Int. Cl. H04N 7/14

(52) U.S. Cl. 348/14.01

(57) ABSTRACT

The present invention relates to an apparatus and a method for managing content, such as pictures, with category information. In the method, when there is a picture to be stored, category information to be entered to the picture is identified. An application header including the category information is created. The picture including the application header is encoded and stored. Accordingly, easy and efficient picture management is achieved.

### PRIORITY

This application claims priority under 35 U.S.C. § 119 to an application entitled “Method For Storing A Picture With Category Information In A Mobile Communication Terminal” filed in the Korean Intellectual Property Office on Jan. 17, 2006 and assigned Serial No. 2006-4868, the contents of which are incorporated herein by reference.

### BACKGROUND OF THE INVENTION

1. Field of the Invention

The present invention relates generally to an apparatus and a method for managing content, such as pictures, in a mobile communication terminal, and more particularly to an apparatus and a method for easy content management including classifying and storing content, with category information, and searching the picture stored in a mobile communication terminal.

2. Description of the Related Art

Mobile communication terminals are widely used due to their ease of portability. Mobile communication terminal manufacturers are developing mobile communication terminals that have an increased amount of convenient functions, such as a phone book, a game, a scheduler, a short message, Internet access, e-mail, an alarm and wake up call.

Also, peripheral devices attached to the mobile communication terminal are being developed. For example, an attachable or built-in digital camera module, a TV reception module for DMB (Digital Multimedia Broadcasting) reception and an MPEG-Layer 3 module for playing MPEG-Layer 3 files.

Particularly, a built-in digital camera in a mobile communication terminal is widely used along with improving capacity of an embedded or external memory and performance of a digital camera module. Accordingly, the number of stored pictures taken by a digital camera, and attached in a mobile communication terminal has increased enormously. However, there is presently no way to manage the pictures effectively and store them collectively in a designated directory.

Therefore, there exists the need for an apparatus and a method for easily managing content, such as pictures, and searching the content stored in a mobile communication terminal.

### SUMMARY OF THE INVENTION

An object of the present invention is to provide an apparatus and a method for classifying and storing content such as pictures using category information in a mobile communication terminal.

Another object of the present invention is to provide an apparatus and a method for searching content such as pictures having category information in a mobile communication terminal.

According to the present invention, there is provided an apparatus for achieving the above objects, the apparatus including a controller for identifying category information for content, creating an application header including the category information and encoding the content including the created application header, and a memory for storing encoded content including the created application header.

According to the present invention, there is provided a method of storing content in a portable terminal including identifying category information for content, creating an application header including the category information, and encoding the content including the created application header.

According to the present invention, there is provided a method for searching stored content in a portable terminal, including searching category information included in the stored content, and selecting content including the category information.

According to the present invention, there is provided a computer-readable recording medium, including a first code segment for identifying category information for content, a second code segment for creating an application header including the category information, a third code segment for encoding the content including the created application header, and a fourth code segment for storing encoded content including the created application header.

### BRIEF DESCRIPTION OF THE DRAWINGS

The above and other objects, features, and advantages of the present invention will become more apparent from the following detailed description when taken in conjunction with the accompanying drawings in which:

FIG. 1 illustrates a block diagram of a mobile communication terminal according to the present invention;

FIG. 2 illustrates a flowchart showing a procedure of assigning category information to a picture taken by a digital camera and storing the picture having the category information in a mobile communication terminal according to the present invention;

FIGS. 3A, 3B and 3C illustrate screens for storing a picture with category information according to the present invention;

FIG. 4 illustrates a structure of a frame header for inputting category information to a picture according to the present invention; and

FIG. 5 illustrates a flowchart showing a procedure of searching a picture using category information according to the present invention.

### DETAILED DESCRIPTION OF THE PREFERRED EMBODIMENTS

Preferred embodiments of the present invention will be described herein below with reference to the accompanying drawings. In the following description, a detailed description of well-known functions or constructions incorporated herein has been omitted for the sake of clarity and conciseness.

Hereinafter, an apparatus and a method for easy content management including classifying and storing content, such as pictures, with category information, and searching the picture stored in a mobile communication terminal will be described. Assigning category information to a picture for easily classifying, storing and searching the picture in a mobile communication will also be described.

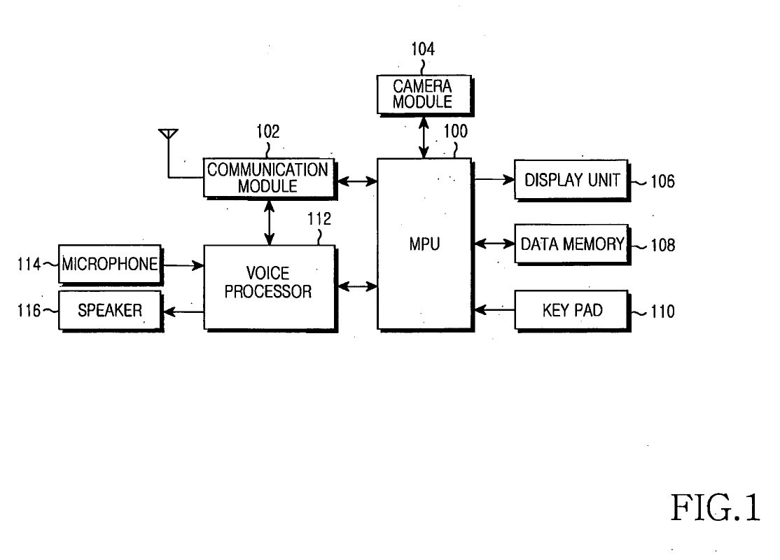

FIG. 1 illustrates a block diagram of a mobile communication terminal according to the present invention.

The mobile communication terminal has a camera module and includes, but is not limited to, a cellular phone, a Personal Communication System (PCS), a Personal Data Assistant (PDA) and International Mobile Telecommunication-2000 (IMT2000). Also, the present invention may apply to a portable terminal that does not have a communication function.

Referring to FIG. 1, the MPU, acting as a controller, 100 controls the overall operation of the mobile communication terminal. The MPU 100 is responsible for processing and controlling voice and data communication. In addition, the MPU 100 processes a function for identifying category information for content, creating an application header including the category information and encoding the content including the created application header. A detailed description of the typical processing and controlling operation of the MPU 100 will not be described herein.

A communication module 102 transmits and receives a wireless signal of communication data through an antenna. A communication module 102 processes data transmission/reception of radio signals, which are transmitted/received through an antenna. For example, when transmitting data, the communication module 102 performs channel coding and spreading of data to be transmitted, and then Radio Frequency (RF) processes and transmits the data. When receiving data, the communication module 102 converts an RF signal received to a baseband signal, and performs de-spreading and channel decoding of the baseband signal.

A camera module 104 converts image data into digital data, and stills the digital data, thereby acquiring still pictures. A display unit 106 displays status information, limited number of characters, moving pictures and still pictures and the like. The display unit 202 may be a Liquid Crystal Display (LCD).

A data memory 108 includes Read Only Memory (ROM), Random Access Memory (RAM) and flash ROM. The ROM stores software of a program for processing and controlling the MPU 100 and all reference data. In particular, the ROM stores software for setting category information for classifying content, such as pictures, stored in the mobile communication terminal. The RAM is a working memory of the MPU and stores temporary data being generated while performing all programs. The flash ROM stores various updatable data, such as a phone book, an outgoing message and an incoming message, and content such as pictures including category information.

A keypad 110 can include numeric keys of digits 0-9 and a plurality of function keys, such as a MENU key, a CANCEL (REMOVE) key, an ENTER key, a TALK key, an END key, an internet connection key and navigation keys (▴/▾/ [symbol] ). The key input data corresponding to a key pressed by the user is transmitted to the MPU 100.

A voice processor 112, which is a Coder-Decoder (CODEC), connected to the MPU 100, a microphone 114 and a speaker 116 connected to the CODEC 112 are audio input/output units for use in voice communication. The MPU 100 produces Pulse Code Modulation (PCM) data and the CODEC 112 converts the PCM data into analog audio signals. The analog audio signals are outputted through the speaker 116. Also, the CODEC 112 converts analog audio signals received through the microphone 114 into PCM data and provides the MPU 100 with the PCM data.

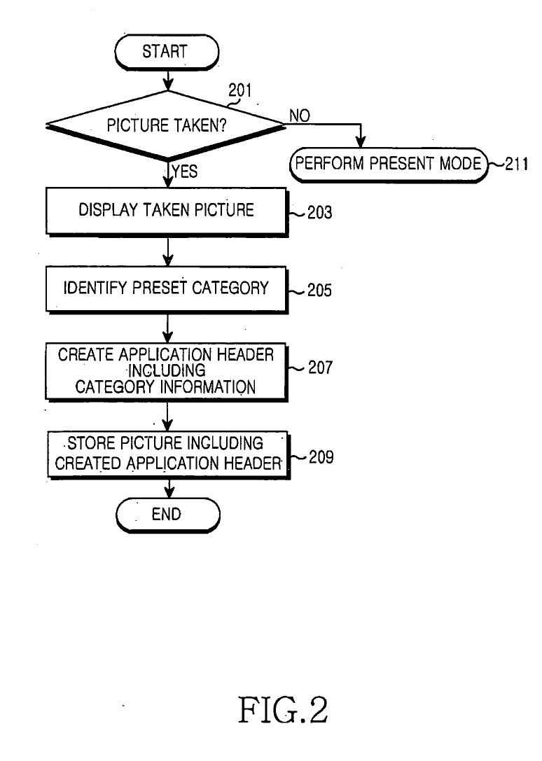

FIG. 2 illustrates a flowchart showing a procedure of assigning category information to a picture taken by a digital camera and storing the picture having the category information in a mobile communication terminal according to the present invention.

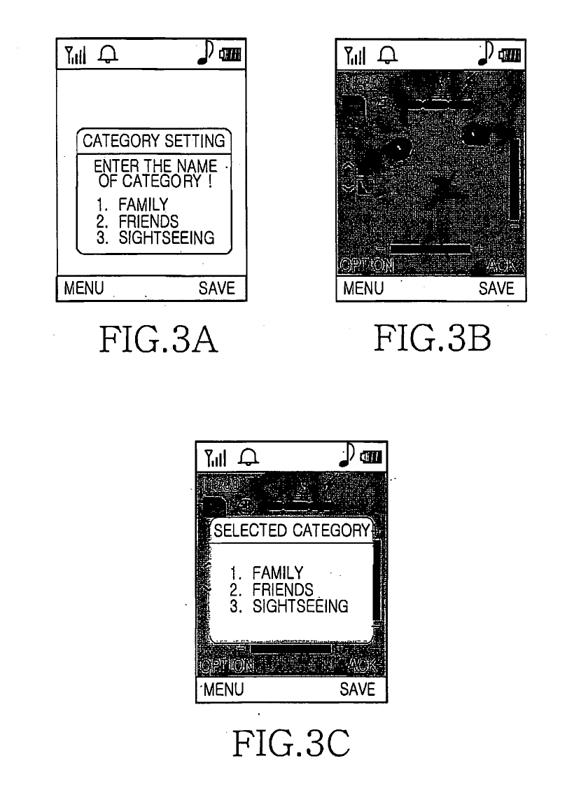

Referring to FIG. 2, the MPU 100 determines whether a picture is taken by a user's key manipulation with the camera module 104 attached or embedded in a mobile communication terminal in step 201. If the picture has not been taken, the MPU 100 proceeds to step 211 to perform the present mode, e.g., a waiting mode. The MPU 100 displays the taken picture on the display unit 106 in step 203, as illustrated in FIG. 3B.

In step 205, the MPU 100 identifies category information preset prior to taking the picture. Here, the category information may include a number of categories as illustrated in FIG. 3A. A picture may be assigned to multiple categories. Selection of category information assigned to the taken picture is illustrated as in FIG. 3C. After identifying the category information, the MPU 100 creates an application header including the category information in step 207.

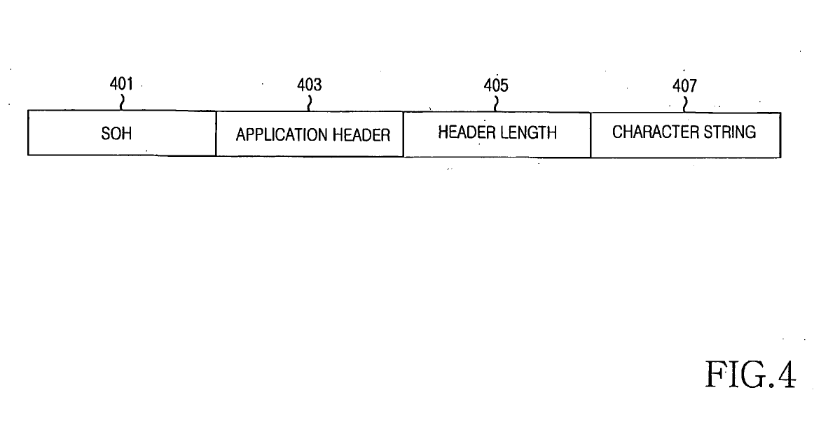

The MPU 100 proceeds to step 209 to store the taken picture including the application header in the data memory 108. When encoding the taken picture to JPEG (Joint Picture Experts Group) format, the MPU 100 inserts the application header including the category information to the frame header of JPEG format and ends the process. Herein, the application header is included in the frame header of the picture as illustrated in FIG. 4 below.

FIGS. 3A, 3B and 3C illustrate screens for storing a picture with category information according to the present invention.

FIG. 3A illustrates a number of categories, such as family, friends and sightseeing, for classifying the pictures.

FIG. 3B illustrates the taken picture on the display unit 106.

FIG. 3C illustrates a selected category information assigned to the taken picture.

FIG. 4 illustrates a structure of a frame header for inputting category information to a picture according to the present invention. In FIG. 4, the frame header includes a Start Of Header (SOH) field 401, an application field 403, a header length field 405 and a character string field 407. The SOH field 401 indicates a start of the frame header.

The application header field 403 can include a total of 16 application headers of FFE0 to FFEF. The application header indicates status information of the picture. Further, category information can be input in the taken picture using the 16 application headers, in which FFE0 is JFIF header and indicates that the frame header is JPEG format, and FFE1 is EXIF header and indicates camera information. Thus, category information of the taken picture is input using 14 application headers of FFE2 to FFEF. Here, FFE2 indicates that the application headers include category information.

The header length field 405 indicates a length of the frame header including 2 bytes. The character string field 407 indicates a character string such as a category name, included in the frame header. For example, if the category information is “1. friends, 2. family”, the application header for each category can be shown as Table 1 below.

TABLE 1

| name | header data |
|---|---|
| friends | FF E3 00 09 66 72 69 65 6E 64 73 |
| family | FF E4 00 08 66 61 6D 69 6C 79 |

As noted in Table 1, in the header data, a number is represented as hexadecimal and a character is represented as American Standard Code for Information Interchange (ASCII) code.

Thus, FFE3 in header data of “friends” indicates an application header and 00 09 indicates a length of the application header represented as hexadecimal. 66 72 69 65 6E 64 73 indicates ASCII code of “friends”. Also, FFE4 in header data of “family” indicates the application header and 00 08 indicates a length of the application header represented as hexadecimal. 66 61 6D 69 6C 79 indicates ASCII code of “family”.

A picture can be included in a plurality of categories.

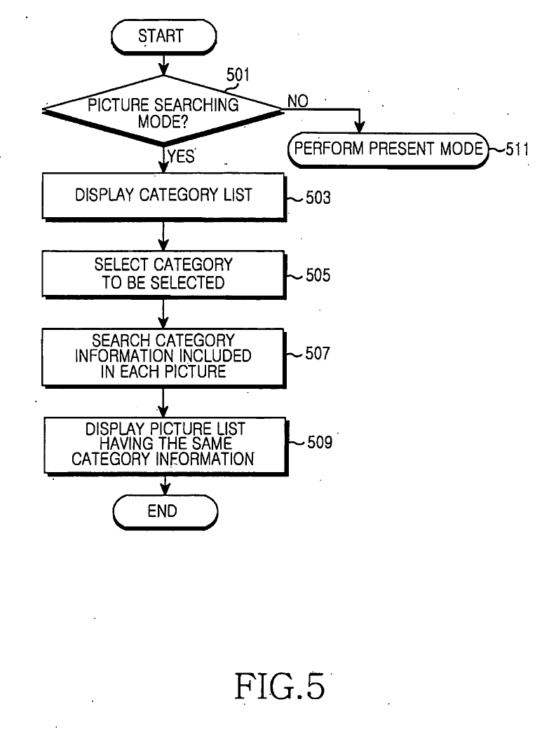

FIG. 5 illustrates a flowchart showing a procedure of searching a picture using category information according to the present invention.

Referring to FIG. 5, the MPU 100 determines whether a picture searching mode is selected by a user's key manipulation in step 501. If the picture searching mode is not selected, the MPU 100 proceeds to step 511 to perform the present mode, such as a waiting mode. The MPU 100 displays a category list of pictures stored in the mobile communication terminal on the display unit 106 in step 503. After displaying the category list, the MPU 100 determines whether the category to be searched is selected from the category list in step 505.

If the category to be searched has been selected, the MPU 100 proceeds to step 507 to search an application header of the stored pictures and identify pictures including the selected category information. For example, if the stored pictures have the same category information as Table 2 below, the MPU 100 identifies pictures including the selected category information.

TABLE 2

| directory | category 1 | category 2 | category 3 |
|---|---|---|---|
| picture 1 | family | food | anniversary |
| picture 2 | anniversary | family | July |
| picture 3 | family | food | March |
| picture 4 | anniversary | friends | June |
| picture 5 | anniversary | food | |
| picture 6 | food | family | |

Here, if category “food” is selected, the MPU 100 searches category information included in the application header of the pictures and identifies picture 1, picture 3, picture 5 and picture 6 including “food” category information.

Next, the MPU 100 displays a list of the identified pictures including the selected category information on the display unit 106 in step 509.

According to the present invention, an apparatus and a method for classifying and storing content such as pictures using category information in a mobile communication terminal are provided for easy and efficient content management. Preferred embodiments of the present invention can also include computer readable codes on a computer readable medium. The computer readable medium can include any data storage device that can store data that can be read by a computer system. Examples of a computer readable medium include magnetic storage media (e.g., Read-Only Memory (ROM), floppy disks and hard disks), optical recording media (e.g., Compact Disc (CD)-ROMs, or Digital Video Discs (DVDs)), and storage mechanisms such as carrier waves (e.g., transmission through the Internet). The computer readable medium can also be distributed over network coupled computer systems so that the computer readable code is stored and executed in a distributed fashion. Also, functional programs, codes and code segments for accomplishing preferred embodiments of the present invention can be understood by programmers of ordinary skill in the art to which the present invention pertains.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A portable terminal, comprising:
a controller for identifying category information for content, creating an application header including the category information and encoding the content including the created application header; and
a memory for storing encoded content including the created application header.

2. The portable terminal of claim 1, wherein the content includes pictures taken by a digital camera.

3. The portable terminal of claim 2, wherein the digital camera is a digital camera module attachable to the portable terminal or an embedded digital camera module in the portable terminal.

4. The portable terminal of claim 2, wherein the picture is encoded to JPEG (Joint Picture Experts Group) format.

5. The portable terminal of claim 1, wherein the category information includes a plurality of categories.

6. The portable terminal of claim 1, wherein the portable terminal is one of a cellular phone, a Personal Communication System (PCS), a Personal Data Assistant (PDA) and International Mobile Telecommunication-2000 (IMT2000).

7. A portable terminal for searching stored content, comprising:
a memory for storing content; and
a controller for searching category information included in the stored content, and selecting content including the category information.

8. The portable terminal of claim 7, wherein the controller further displays a list of the selected content.

9. The portable terminal of claim 7, wherein the content includes pictures taken by a digital camera.

10. The portable terminal of claim 7, wherein the portable terminal is one of a cellular phone, a Personal Communication System (PCS), a Personal Data Assistant (PDA) and International Mobile Telecommunication-2000 (IMT2000).

11. A method of storing content in a portable terminal, comprising:
identifying category information for content;
creating an application header including the category information; and
encoding the content including the created application header.

12. The method of claim 11, further comprising storing encoded content including the created application header.

13. The method of claim 11, wherein the content includes pictures taken by a digital camera.

14. The method of claim 13, wherein the digital camera is a digital camera module attachable to the portable terminal or an embedded digital camera module in the portable terminal.

15. The method of claim 13, wherein the picture is encoded to JPEG (Joint Picture Experts Group) format.

16. The method of claim 13, wherein the portable terminal is one of a cellular phone, a Personal Communication System (PCS), a Personal Data Assistant (PDA) and International Mobile Telecommunication-2000 (IMT2000).

17. A method for searching stored content in a portable terminal, comprising:
searching category information included in the stored content, and
selecting content including the category information.

18. The method of claim 17, further comprising displaying a list of the selected content.

19. The method of claim 17, wherein the content is pictures taken by a digital camera.

20. The method of claim 17, wherein the portable terminal is one of a cellular phone, a Personal Communication System (PCS), a Personal Data Assistant (PDA) and International Mobile Telecommunication-2000 (IMT2000).

21. A computer-readable recording medium readable by a machine, comprising:
a first code segment, for identifying category information for content;
a second code segment, for creating an application header including the category information;
a third code segment, for encoding the content including the created application header; and
a fourth code segment for storing encoded content including the created application header.
